(19) United States
(12) Patent Application Publication
(10) Pub. No.: US 2014/0017929 A1
(43) Pub. Date: Jan. 16, 2014

(54) CONNECTOR

(71) Applicant: Yazaki Corporation, Tokyo (JP)

(72) Inventors: Naokazu NAGASAKA, Shizuoka (JP); Takumi NAKAGISHI, Shizuoka (JP)

(73) Assignee: YAZAKI CORPORATION, Tokyo (JP)

(21) Appl. No.: 14/031,337

(22) Filed: Sep. 19, 2013

Related U.S. Application Data
(63) Continuation of application No. PCT/JP2012/057177, filed on Mar. 21, 2012.

(30) Foreign Application Priority Data
Mar. 23, 2011 (JP) 2011-063932

(51) Int. Cl. H01R 13/627

(52) U.S. Cl. CPC H01R 13/6278
USPC 439/350

(57) ABSTRACT

A connector includes a terminal reception chamber that is to receive a terminal therein and is provided with an opening on a connection part side of the terminal, a terminal support part that is provided on the opening side of the terminal reception chamber and is to support the terminal at an undersurface side thereof, and a locking lance that is flexibly provided in the terminal reception chamber and is to lock the terminal. The terminal is provided with a protruding engaged part along the overall width thereof such that the protruding engaged part protrudes below the terminal support part when supported by the terminal support part. The locking lance is provided with an engaging part that is positioned below the terminal support part and is to engage with the protruding engaged part. The engaging part is provided along the overall width of the terminal.

### CROSS REFERENCE TO RELATED APPLICATION

This is a continuation application based on PCT application No. PCT/JP2012/057177 filed on Mar. 21, 2012, which claims the benefit of priority from Japanese Patent Application No.2011-063932 filed on Mar. 23, 2011, the entire contents of which are incorporated by reference herein.

### BACKGROUND OF THE INVENTION

1. Field of the Invention

The present invention relates to a connector.

2. Description of the Related Art

As a terminal to be received in a connector, there has been known one provided with a terminal lance for preventing falling-off from the back of a terminal reception chamber in a connector housing, where the terminal lance includes a turn-up part folded along the width direction of a connection part of the terminal and is formed by bending with a predetermined angle along the overall width in the outer direction (see Japanese Patent Application Laid-Open Publication No. 2002-280106 for example).

When the terminal is inserted into the terminal reception chamber of the connector housing, the terminal lance is bent downward by the ceiling wall, and when the terminal is positioned in a predetermined position, the terminal lance is restored upward, which allows the rear end of the terminal lance to engage with a step locking part provided on the ceiling wall, thereby preventing the terminal from falling off from the terminal reception chamber.

In such a locking configuration including the terminal lance and the step locking part, since the terminal lance is formed along the overall width, the terminal is stably locked in the terminal reception chamber and the falling-off of the terminal from the terminal reception chamber is surely prevented.

However, in the above-described locking configuration, since the terminal has the terminal lance provided thereon as a locking lance and the locking lance has rigidity, the insertion force of the terminal into the terminal reception chamber is increased. Also, when the terminal is taken out from the terminal reception chamber, there is a need of bending the locking lance of the terminal which is electrical continuity material, by a release jig or the like. This requires a careful work, which deteriorates the workability.

On the other hand, in a configuration where the locking lance is provided on a connector, the terminal is provided with an engaged part comprised of a hole part such as a lance hole, and the locking lance is provided with a protruding engaging part which is to engage with the engaged part of the terminal. Also, the connector is provided with a pair of terminal support parts on the both side walls of the terminal reception chamber, which support the terminal at the undersurface sides of the both sides in the width direction of the connection part side of the terminal, and the locking lance is flexibly provided between the pair of support parts.

In the above-described connector, since the protruding engaging part of the locking lance is restricted by the pair of support parts positioned at the both sides in the width direction, the protruding engaging part can not be provided along the overall width. Also, if the projection of the pair of support parts is lowered in order to provide the protruding engaging part along the overall width of the terminal, the support of the terminal in the terminal reception chamber becomes unstable.

### SUMMARY OF THE INVENTION

The invention has an object to provide a connector that improves locking of a terminal by a locking lance and stability in supporting the terminal in a terminal reception chamber.

The present invention provides a connector including: a terminal reception chamber that is to receive a terminal therein and is provided with an opening on the side of a connection part of the terminal; a terminal support part that is provided on the side of the opening of the terminal reception chamber and is to support the terminal at the side of an undersurface thereof; and a locking lance that is flexibly provided in the terminal reception chamber and is to lock the terminal, wherein the terminal is provided with a protruding engaged part along the overall width thereof, in such a manner that the protruding engaged part protrudes below the terminal support part when supported by the terminal support part, the locking lance is provided with an engaging part that is positioned below the terminal support part and is to engage with the protruding engaged part, and the engaging part is provided along the overall width of the protruding engaged part of the terminal.

In this connector, the terminal is provided with the protruding engaged part along the overall width thereof, in such a manner that the protruding engaged part protrudes below the terminal support part when supported by the terminal support part, and the locking lance is provided with the engaging part that is positioned below the terminal support part and is to engage with the protruding engaged part, which enables to independently configure the support of the terminal by the terminal support part and the locking of the terminal by the locking lance. Accordingly, flexibility in the design of the terminal support part is improved and stability of supporting the terminal in the terminal reception chamber is improved.

Also, the engaging part of the locking lance is provided along the overall width of the terminal, which allows the engagement between the protruding engaged part of the terminal and the engaging part of the locking lance to be performed in a wide range, thereby surely preventing the terminal from falling off from the terminal reception chamber.

Therefore, in the above-described connector, locking of the terminal by the locking lance is improved and stability of supporting the terminal in the terminal reception chamber is improved.

According to a preferred embodiment of the present invention, the terminal support part is provided along the overall width of the terminal reception chamber.

In this connector, since the terminal support part is provided along the overall width of the terminal reception chamber, even though the terminal is moved in the terminal reception chamber, the terminal is supported by the terminal support part, thereby further improving the stability of supporting the terminal in the terminal reception chamber.

According to the present invention, there is an effect to provide a connector that improves locking of a terminal by a locking lance and stability in supporting the terminal in a terminal reception chamber.

### BRIEF DESCRIPTION OF THE DRAWINGS

FIG. 1 is a perspective view of a terminal for a connector according to an embodiment of the present invention.

FIG. 2 is a cross-sectional view of the connector according to the embodiment of the present invention.

FIG. 3A is a cross-sectional view of the connector according to the embodiment of the present invention.

FIG. 3B is a front view of the connector according to the embodiment of the present invention.

### DESCRIPTION OF THE EMBODIMENTS

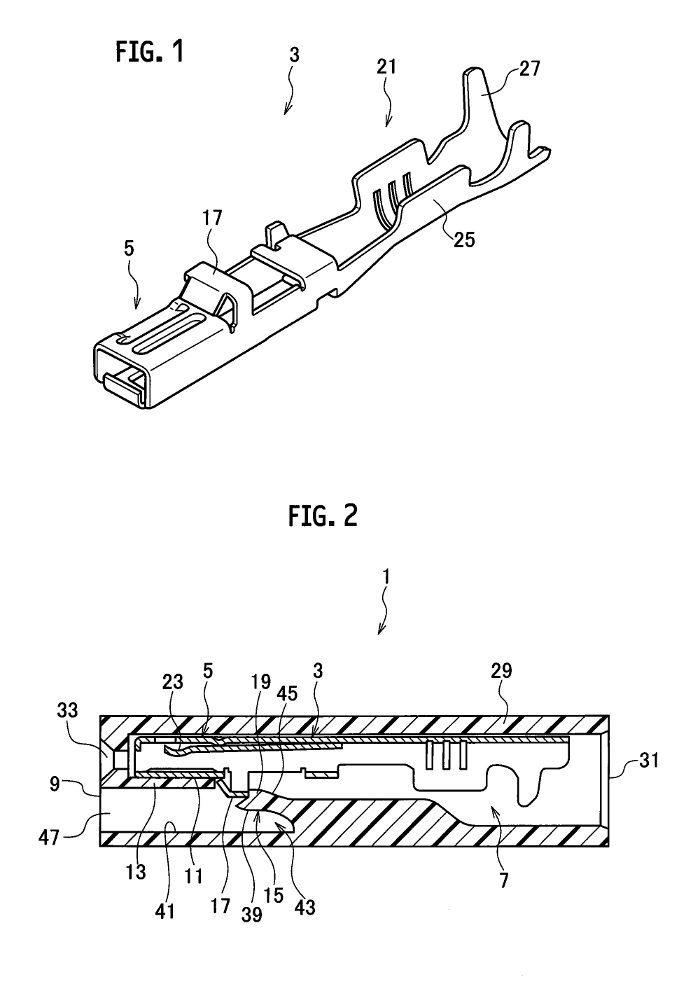

A connector according to an embodiment of the present invention will be described with reference to FIGS. 1 to 3B.

A connector 1 according to the present embodiment includes a terminal reception chamber 7 which is to receive a terminal 3 therein and has an opening on the side of a connection part 5 of the terminal 3, a terminal support part 13 which is provided on the side of an opening 9 of the terminal reception chamber 7 and is to support the terminal 3 at the side of an undersurface 11 thereof, and a locking lance 15 which is flexibly provided in the terminal reception chamber 7 and is to lock the terminal 3.

The terminal 3 is provided with a protruding engaged part 17 along the overall width in such a manner that the protruding engaged part 17 protrudes below the terminal support part 13 when supported by the terminal support part 13. The locking lance 15 is provided with an engaging part 19 which is positioned lower than the terminal support part 13 and is to engage with the protruding engaged part 17, where the engaging part 19 is provided along the overall width of the terminal 3.

Also, the terminal support part 13 is provided along the overall width of the terminal reception chamber 7.

As shown in FIG. 1, the terminal 3 is made of electrically conductive material and provided with the connection part 5, an electric wire fixation part 21 and the protruding engaged part 17. The connection part 5 has a spring 23 therein, which is elastically deformable (see FIG. 2). A connection part of the opposing terminal (not shown) such as a tab, is inserted in the connection part 5 to come into elastic contact with the coil 23, thereby electrically connecting the terminal 3 to the opposing terminal.

The electric wire fixation part 21 has a core wire fixation part 25 to which a core wire of a covered electric wire (not shown) is to be electrically connected and caulked, and a covered fixation part 27 which is to fix the coated electric wire by caulking a covered part of the covered electric wire. By fixing the covered electric wire to the electric wire fixation part 21, an electrical component and the like (not shown) connected to the covered electric wire are electrically connected with the terminal 3.

The protruding engaged part 17 is provided along the overall width on the side of the connection part 5. As shown in FIG. 2, the length of protrusion of the protruding engaged part 17 is set in such a way that the protruding engaged part 17 is positioned lower than the terminal support part 13 when the terminal 3 is received in the terminal reception chamber 7. The above-described terminal 3 is to be received in the terminal reception chamber 7.

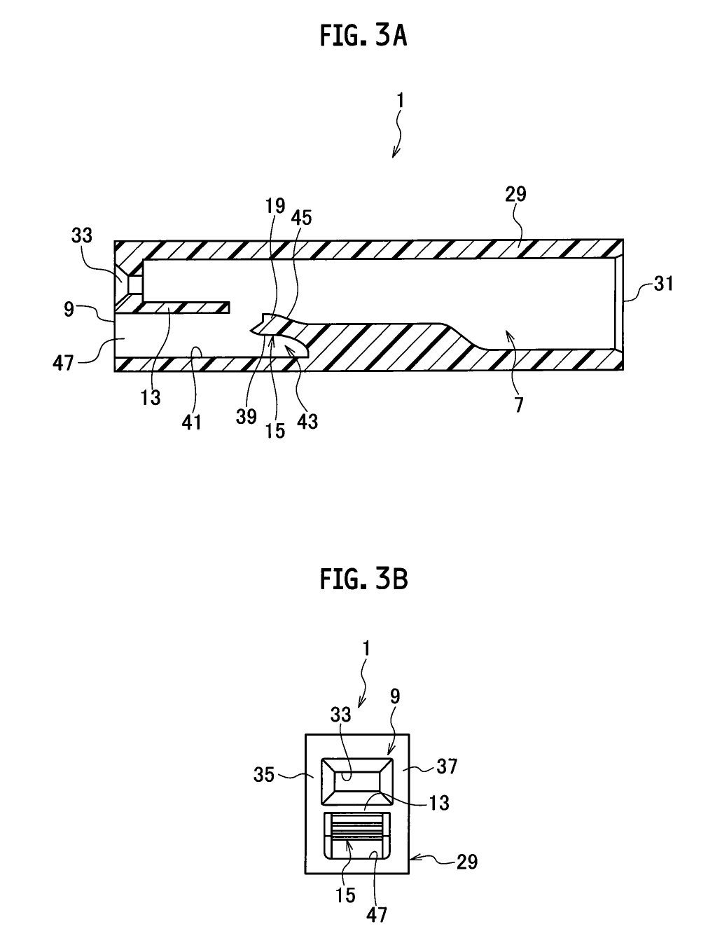

As shown in FIGS. 2, 3A, and 3B, the terminal reception chamber 7 is provided to extend in the length direction of a housing 29. The terminal 3 is inserted from the side of an insertion opening 31, and the side of the connection part 5 of the terminal 3 is placed on the side of the opening 9. The terminal 3 is received in the terminal reception chamber 7 as described above, and the housing 29 is engaged with the opposing housing (not shown). The connection part of the opposing terminal such as a tab is inserted into a connection part insertion opening 33 on the side of the opening 9, thereby connecting the connection part 5 of the terminal 3 to the opposing terminal. The side of the connection part 5 of the terminal 3 received in the terminal reception chamber 7 is supported by the terminal support part 13.

The terminal support part 13 is provided on both side walls 35 and 37 along the overall width of the terminal reception chamber 7 as one member continuing from the housing 29, and extends in the length direction from the side of the opening 9 to a part in which the protruding engaged part 17 of the terminal 3 is to be placed. The terminal support part 13 supports the terminal at the side of the undersurface 11 of the side of the connection part 5 of the terminal 3 in when the terminal 3 is received in the terminal reception chamber 7. The locking lance 15 is provided below the terminal support part 13.

The locking lance 15 is flexibly provided in a flexible space 43 formed between an undersurface 39 thereof and an inside wall surface 41 of the terminal reception chamber 7. The locking lance 15 is positioned lower than the terminal support part 13. When the terminal 3 is received in the terminal reception chamber 7 from the side of the insertion opening 31, an inclined surface 45 comes into contact with the protruding engaged part 17 of the terminal 3, thereby bending the locking lance 15 downward. In this state, when the terminal 3 is inserted toward the side of the opening 9 and the terminal 3 comes to be supported by the terminal support part 13 at the side of the undersurface 11 of the side of the connection part 5 of the terminal 3, the locking lance 15 restores upward. The locking lance 15 is provided with the engaging part 19 that engages with the protruding engaged part 17 of the terminal 3 on this occasion.

For the locking lance 15, the engaging part 19 is provided along the overall width of the terminal 3 so as to engage with the protruding engaged part 17 of the terminal 3 in the overall width. When the terminal 3 is received in the terminal reception chamber 7, the locking lance 15 is restored upward, which allows the engaging part 19 to engage with the protruding engaged part 17 of the terminal 3, thereby preventing the terminal 3 from falling off from the terminal reception chamber 7.

Incidentally, the engagement between the engaging part 19 of the locking lance 15 and the protruding engaged part 17 of the terminal 3 is released by inserting a release jig (not shown) from a jig insertion opening 47 provided on the side of the opening 9 and contacting the release jig to the tip part of the locking lance 15, thereby bending the locking lance 15 downward, so that the terminal 3 is taken off from the terminal reception chamber 7. Also, after the terminal 3 is received in the terminal reception chamber 7, a restriction member (not shown) such as a spacer is inserted from the jig insertion opening 47 to be arranged in the flexible space 43, which restricts the locking lance 15 from being bent downward, thereby preventing the release of the engagement between the protruding engaged part 17 and the engaging part 19.

For the connector 1, the terminal 3 is provided with the protruding engaged part 17 along the overall width in such a manner that the protruding engaged part 17 protrudes below the terminal support part 13 when supported by the terminal support part 13, and the locking lance 15 is provided with the engaging part 19 which is provided lower than the terminal support part 13 and is to engage with the protruding engaged part 17. This enables to independently configure the support of the terminal 3 by the terminal support part 13 and the locking of the terminal 3 by the locking lance 15. Accordingly, flexibility in the design of the terminal support part 13 is improved and stability of supporting the terminal 3 in the terminal reception chamber 7 is improved.

Also, the engaging part 19 of the locking lance 15 is provided along the overall width of the terminal 3, which allows the engagement between the protruding engaged part 17 of the terminal 3 and the engaging part 19 of the locking lance 15 to be performed in a wide range, thereby surely preventing the terminal 3 from falling off from the terminal reception chamber 7.

Therefore, in the above-described connector 1, locking of the terminal by the locking lance 15 is improved and stability of supporting the terminal 3 in the terminal reception chamber 7 is improved.

In this connector, since the terminal support part 13 is provided along the overall width of the terminal reception chamber 7, even though the terminal 3 is moved in the terminal reception chamber 7, the terminal 3 is supported by the terminal support part 13, thereby further improving the stability of supporting the terminal 3 in the terminal reception chamber 7.

Incidentally, the connector according to the embodiment of the present invention has a configuration where the housing is provided with only one terminal reception chamber, but not limited to this. The configuration of the present invention may be also applied to a configuration where the housing is provided with a plurality of terminal reception chambers.

What is claimed is:

1. A connector comprising:
a terminal reception chamber that is to receive a terminal therein and is provided with an opening on the side of a connection part of the terminal;
a terminal support part that is provided on the side of the opening of the terminal reception chamber and is to support the terminal at the side of an undersurface thereof; and
a locking lance that is flexibly provided in the terminal reception chamber and is to lock the terminal,
wherein the terminal is provided with a protruding engaged part along the overall width thereof, in such a manner that the protruding engaged part protrudes below the terminal support part when supported by the terminal support part,
the locking lance is provided with an engaging part that is positioned below the terminal support part and is to engage with the protruding engaged part, and
the engaging part is provided along the overall width of the protruding engaged part of the terminal.

2. The connector according to claim 1,
wherein the terminal support part is provided along the overall width of the terminal reception chamber.
